(19) United States
(12) Patent Application Publication
(10) Pub. No.: US 2009/0054048 A1
(43) Pub. Date: Feb. 26, 2009

(54) Apparatus and Method for Configuration of Telecommunication Terminals

(76) Inventors: Wilfred Tobben, Bocholt (DE); Jorg Wienand, Bocholt (DE)

Correspondence Address: STAAS & HALSEY LLP, SUITE 700, 1201 NEW YORK AVENUE, N.W., WASHINGTON, DC, 20005, US

(21) Appl. No.: 12/083,069

(22) PCT Filed: Aug. 3, 2006
(86) PCT No.: PCT/EP2006/007712

§ 371 Date: Apr. 3, 2008

(51) Int. Cl. H04M 3/00

(52) U.S. Cl. 455/418

(57) ABSTRACT

An apparatus and a method for configuration of terminals, in which a service detection unit detects a service to be configured for that terminal, and a transmitting/receiving unit transmits/receives at least configuration data via a communication network. A control unit drives the transmitting/receiving unit such that configuration data associated with the detected service is loaded from a configuration server, with a configuration unit configuring the terminal for the detected service by means of the loaded configuration data. In this way, the configuration data that has been entered by a small number of users can be made available easily and at low cost to a multiplicity of other users.

### CROSS-REFERENCE TO RELATED APPLICATIONS

This application is based on and hereby claims priority to PCT Application No. PCT/EP2006/007712 filed on Aug. 3, 2006, the contents of which are hereby incorporated by reference.

### BACKGROUND

The inventors have studied an apparatus and a method for configuration of telecommunication terminals and in particular to an apparatus and a method for configuration of terminals for IP-based services (Internet protocol) such as VoIP (voice over IP).

To configure terminals, data memory chips inside the terminal are usually exchanged or modified, or extensive data input is entered via the terminal's user interface. Configuration can also be carried out by connecting the terminal to a so called host computer or to an equivalent programming device. Configuration, in this manner, however, requires technical expertise and in some cases even specially trained support personnel.

In particular the configuration of telecommunication terminals for IP-based services (Internet protocol) such as VoIP (voice over IP) is at the present time extremely complex and moreover still dependent on the service providers concerned.

Since to date the configuration of such terminals has been carried out by manually entering parameters through an input keyboard, even though a plurality of parameters have to be entered and furthermore an input keyboard, in particular in the case of mobile terminals, is very small and therefore not user-friendly, there exists a need to provide support for users when they are configuring their terminals.

A possible way of achieving this is for the terminal to be preinstalled by the manufacturer or service provider and the parameters concerned to be installed in advance on the manufacturer's or service provider's premises. This style of preconfiguration, however, is extremely time-consuming and therefore expensive.

So-called remote device management systems are also known, whereby configuration data can be downloaded from a server into a terminal needing to be configured.

### SUMMARY

Hence for the purpose of configuring terminals, and being preferably implemented therein, the apparatus proposed by the inventors has a service detection unit for detecting a service that requires to be configured for the terminal; a transmitting/receiving unit for transmitting/receiving at least configuration data over a telecommunication network; a control unit for controlling said transmitting/receiving unit in such a way that configuration data pertaining to the detected service is downloaded from a configuration server in the network and treated as the current configuration data; and a configuration unit that configures the terminal for the detected service by the current configuration data. Thus configuration data stored centrally on a configuration server can be downloaded into any terminal requiring to be reconfigured and in this way the terminal can be very easily configured.

Preferably the apparatus further has a configuration data input unit for manually entering configuration data for the service that needs to be configured, it being possible for the control unit to route the manually entered configuration data to the configuration unit as the current configuration data for the service, and to transmit said data, via the transmitting/receiving unit, to the configuration server in the network. If therefore no suitable configuration data is available on the configuration server, a user can also enter the configuration data manually, said data being automatically transmitted to the configuration server which in turn can make it available to subsequent users. The cost of maintaining the configuration data is thus greatly reduced.

Furthermore a configuration function test unit for carrying out a function test on the terminal in the course of the current configuration can be run for the detected service, thereby ascertaining function test information. Said ascertained function test information can further be sent to the configuration server with the associated current configuration data and associated detected service. In this way the configuration data transmitted by the terminal can also be evaluated for quality, enabling the database to be optimized on the configuration server.

Preferably the configuration data and associated service are only transmitted to the configuration server when the function test performed on the terminal had a successful outcome. In this way the occurrence of defective data sets on the configuration server can be reliably prevented, thereby greatly improving the overall benefit.

With regard to the method for configuring the terminal, first a service that needs to be configured for the terminal is detected and then suitable configuration data for the detected service is downloaded from a configuration server over a telecommunication network and treated as current configuration data. Next the terminal is configured for the detected service on the basis of said current configuration data. This greatly increases user friendliness, since the only input needed is the service that is required to be configured. All further data that may be needed is already specifically preassigned for the terminal and if necessary can be automatically communicated or read out without further effort on the part of the user.

Preferably the configuration server is checked for the availability of configuration data for the detected service, said configuration data being downloaded if available, or created manually by the user if not.

Preferably a check can be made for the existence of a manual creation of configuration data for the detected service, the current configuration data and the detected service concerned being transmitted to the configuration server when the check found manual input to be present. This ensures that whenever a configuration is not yet available for a predetermined service and a predetermined terminal, it is also communicated to the configuration server and thus in turn made available to subsequent users.

Regarding the server-side method for supporting configuration, messages from terminals, transmitted over a telecommunication network, are first detected and the detected terminal messages are checked, suitable configuration data for a predetermined service being determined from a configuration list and then transmitted to the terminal making the inquiry if said inquiry concerns configuration data for a service requiring to be configured, and on the other hand configuration data being evaluated if the terminal messages are configuration data for an associated service. A configuration list is then modified by reference to the configuration data evaluation. In this way all the configuration data available in a telecommunication network for building a configuration database can be collected together, while on the other hand a suitable data set can be dispatched in the event of a relevant inquiry.

When configuration data for a certain service is evaluated, the transmitted configuration data is preferably compared with the configuration data in the configuration list on the configuration server and the frequency with which an appropriate configuration data set occurs for identical configuration data is determined. It is also possible for only predetermined parameters in the configuration data to be compared and the frequency with which identical predetermined parameters occur to be determined. In this way a statistical optimization process takes place, it being possible to use the determined frequency as an indicator of the reliability of the configuration data set.

The frequency with which parameters or configuration data sets occur can furthermore be checked, supplementary information being transmitted, in particular an exclusion of warranty for a dispatched configuration data set if the frequency of occurrence is below a predetermined threshold. If therefore only low empirical values exist for a given configuration data set or configuration, this fact can be displayed as supplementary information on the terminal of a new user when appropriate.

During the evaluation of configuration data, moreover, the frequency with which the parameters for generating a composite configuration data set occur is preferably used, whereby even completely new configuration data sets can be generated in the configuration server, said data sets then combining the configuration data from different configurations or configuration data sets. In this way optimized configuration data sets can be very quickly and easily generated.

Furthermore function test information can be evaluated if a terminal message concerns function test information about predetermined configuration data for a particular service, the configuration list being moreover modified by reference to said function test information. In this way the configuration data sets in the configuration list can for example be further rearranged or assessed on the basis of quality characteristics. The quality of the configuration list is further improved by this method.

The above-described embodiments of the present invention are intended as examples, and all embodiments of the present invention are not limited to including the features described above.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a simplified block diagram of a telecommunication system illustrating one embodiment of the proposed apparatus and the proposed method;

FIG. 2 is a simplified block diagram of an apparatus for configuring terminals;

FIG. 3 is a simplified flow diagram illustrating significant steps in the terminal-side method for configuring terminals; and

FIG. 4 is a simplified flow diagram illustrating significant steps in the server-side method for configuring terminals.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The proposed method and apparatus will be described below with the aid of mobile telecommunication terminals such as mobile telephones or smart phones which need to be configured for a VoIP service (e.g. a SIP service, session initiated protocol). The method and apparatus are not however limited to this application, also applying in equal measure to alternative telecommunication terminals, and in particular also to hardwired terminals and alternative services.

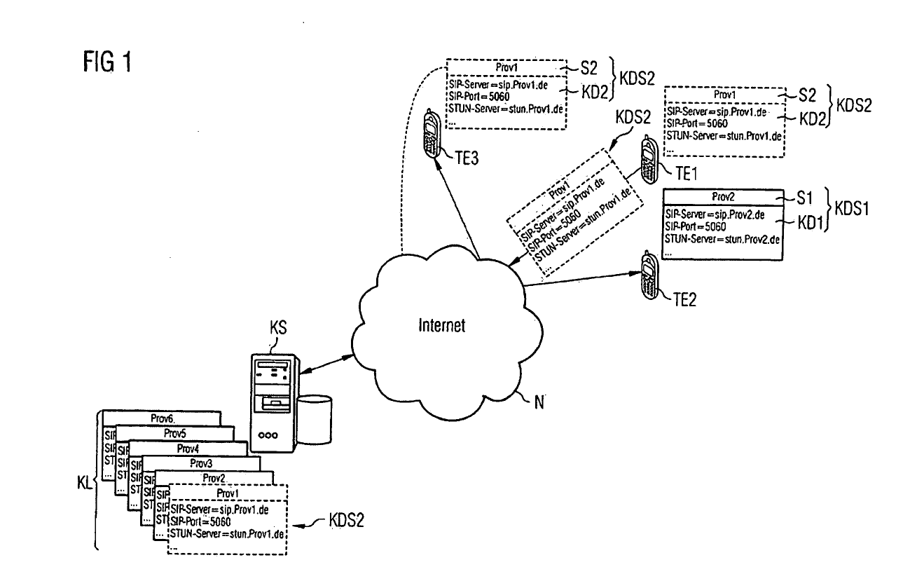

FIG. 1 shows a simplified block diagram of a so-called client-server system illustrating the apparatus and the method.

According to FIG. 1, in a configuration server KS basic data can be stored in advance in the form of a configuration list KL in order to simplify the configuration of telecommunication terminals TE1 to TE3. In this case the telecommunication terminals represent clients. In the very beginning, however, the configuration server KS may contain no configuration data whatsoever.

The first users of a service provider for whom there are still no configuration data sets on the configuration server KS are first of all therefore obliged to enter the configuration data KDx manually via appropriate input devices (keyboard, touch screen, etc.) on the telecommunication terminals TE1 to TE3.

According to FIG. 1, at first the configuration server KS does not yet have a configuration data set KDS2 for the SIP service S2 that is provided by the service provider “Prov1” and needs to be configured, for which reason the corresponding configuration data KD2 must first be entered manually by the user of the telecommunication terminal TE1. An example of this configuration data KD2 may be as follows:

SIP-Server=sip.Prov1.de

SIP-Port=5060

STUN-Server=stun.Prov1.de

When configuration is complete the telecommunication terminal TE1 communicates this new configuration data set KDS2, including the service S2 requiring configuration and the associated configuration data KD2, to the configuration server KS over a network N. Preferably a packet switched network N is used, in particular an IP-based network such as the Internet. Henceforth the configuration server KS collects configuration data sets of the KDSx type (where x=1 to n) and compares them with configuration data sets that have already arrived from further terminals. Stated more precisely, the incoming configuration data set KDS2 is compared with configuration data sets KDSx which have already been transmitted from other terminals (not shown) or have already been preconfigured in a basic data set, the number or frequency with which matches for each known configuration data set KDSx occur being stored.

With effect from a certain number or frequency of matches between the configuration data sets already known and the incoming configuration data set, the configuration server KS can accept said configuration data set into its configuration list KL and said configuration data set is thereby released. From then on, all further users benefit from the configuration work of the first users. In particular an operator of the configuration server KS is relieved of a considerable burden, since the data maintenance cost is minimal.

Hence, according to FIG. 1, if the configuration data set KDS2 transmitted by the telecommunication terminal TE1 turns out to be the third matching configuration data set (match threshold=3), then the configuration data set KDS2 is added to the configuration list KL and thereby released.

If, say, a user of a telecommunication terminal TE2 wishes to configure an as yet unconfigured SIP service S1 from the service provider “Prov2”, then the terminal TE2 can for example transmit a configuration data request for the unconfigured service S1 over the network N to the configuration server KS, which evaluates said request. As a basic principle a server can automatically answer such a request with a list of all services, from which the telecommunication terminal can then choose. Provided a configuration data set for the unconfigured service S1 can be found in the configuration list KL released by the configuration server KS, said data set is selected and transmitted over the network N to the telecommunication terminal TE2 in order to configure it on the spot automatically or when the user gives confirmation. According to FIG. 1 a configuration data set KDS1 of the above type for the service S1 contains the configuration data KD1:

SIP-Server=sip.Prov2.de

SIP-Port=5060

STUN-Server=stun.Prov2.de

It goes without saying that in addition to service providers or the service Sx that needs to be configured, further identifying features can also be transmitted, such as that of the telecommunication terminal, if the configuration data must additionally be set up on a particular type of terminal.

According to FIG. 1 a user of a terminal TE3 can further require a configuration for the unconfigured service S2 from the service provider “Prov1”. Since a corresponding configuration data set KDS2 has already been entered on the terminal TE1 and transmitted to the configuration server KS, and said configuration data set KDS2 has also already been released by being accepted in the configuration list KL, the configuration data KD2 entered by the user of the terminal TE1 can henceforth be automatically transmitted to the terminal TE3 and stored there, by which configuration of the terminal TE3 is greatly simplified. Further terminals (not shown) are configured in the same way.

In order to ensure a certain level of quality in the configuration data sets KDSx contributed by the users, the terminal can have a certain amount of intelligence, enabling it to perform a function test for example. It would be possible, for instance, for the terminal to give the OK only to those service provider's configuration data sets KDSx that have actually worked. It is further possible to envisage a detailed evaluation of the configuration data set being made available in the form of function test information Fl.

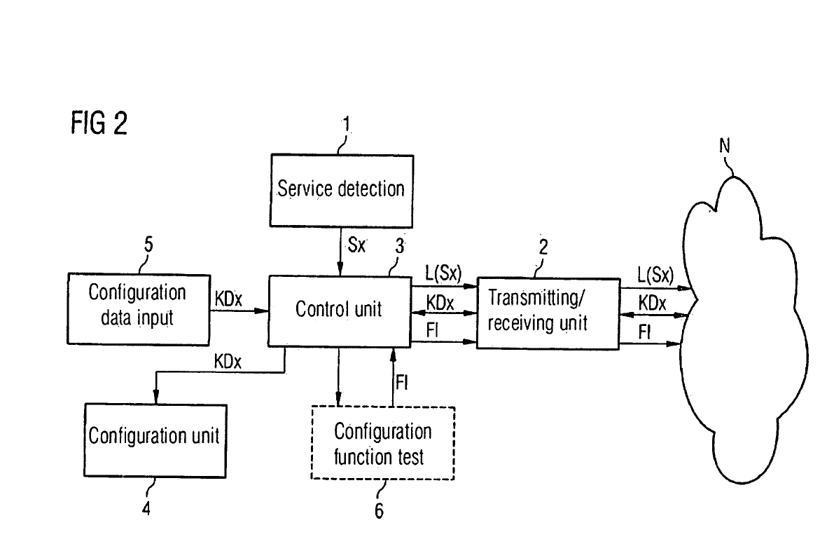

FIG. 2 shows a simplified block diagram of an apparatus for configuring terminals, such as can be provided in the telecommunication terminal TE according to FIG. 1.

According to FIG. 2, the terminal can have a service detection unit 1 for detecting a service Sx that requires to be configured for the terminal TE. If the intention is to configure for example a service known as VoIP (voice over IP) on the mobile telecommunication terminal TE, the user can select this by a display and a keypad. A transmitting/receiving unit 2 is used to transmit/receive at least configuration data KDx over the network N shown in FIG. 1. A transmitting/receiving unit is used when connecting to a packet switched network such as an IP-based network and in particular the Internet. Although the actual configuration data KDx is basically the data that needs to be transmitted, the configuration data sets KDSx described above are preferably also transmitted via the network N.

According further to FIG. 2, a control unit 3 is provided which can control the transmitting/receiving unit 2 in such a way that associated configuration data KDx or an associated configuration data set KDSx is now downloaded via the telecommunication network N by the configuration server KS to the service Sx which was detected by the service detection unit 1 and needs to be configured. The configuration server in turn can also automatically provide a list of services from which an appropriate service is then selected in the terminal. In this case the configuration data downloaded in this way is treated by the control unit 3 as current configuration data and routed to a configuration unit 4. The configuration unit 4 then configures the terminal TE for the detected service Sx by the current configuration data KDx or by the current configuration data set KDSx.

Optionally the terminal can furthermore run a configuration function test unit 6 for carrying out a function test on the current configuration of the terminal TE for the detected service, thereby ascertaining function test information Fl which can be sent to the control unit 3 as output. Hence for example content can be determined as the function test information, from which it becomes apparent whether the current configuration carried out for the detected service Sx was successful and in principle, therefore, the service can be run. In addition to YES/NO information of this type, the function test information can also refer to a quality, with further quality features of the checked service Sx being determined using the configuration concerned.

According to FIG. 2, function test information Fl of this kind can then be forwarded by the control unit 3 to the transmitting/receiving unit 2, which transmits said function test information Fl for example along with the current configuration data set KDSx or the current configuration data KDx and the associated service Sx to the configuration server KS.

To initialize the procedure for downloading the configuration data KDx or the configuration data set KDSx, the control unit 3 issues for example a configuration data request command L(Sx) to the transmitting/receiving unit 2, which transmits said configuration data request via the network N to the configuration server KS. If a corresponding configuration data set KDSx for this configuration data request L(Sx) or for the detected service Sx is released and available in the configuration list KL, said data set KDSx is forwarded to the transmitting/receiving unit 2 and routed via the control unit 3 to the configuration unit 4 for configuration purposes.

If such a download procedure is not possible, because for example a suitable configuration data set does not exist or is not yet released, the configuration data KDx can instead be entered manually for the service Sx needing to be configured, by a configuration data input unit 5. This input can be entered for example by an input unit such as a keypad or a touch-sensitive screen. According to FIG. 2, said manually entered configuration data KDx is in turn routed to the configuration unit 4 as the current configuration data KDx for the service Sx and sent via the transmitting/receiving unit 2 to the configuration server KS in the network N. If there is a configuration function test unit 6, said manually entered configuration data and currently used configuration data KDx can be transmitted to the configuration server KS together with the associated service Sx as the configuration data set KDSx only if an optionally performed function test was successful and in principle the service Sx could be run. In this case the function test information Fl can of course also be generated and transmitted to the configuration server KS.

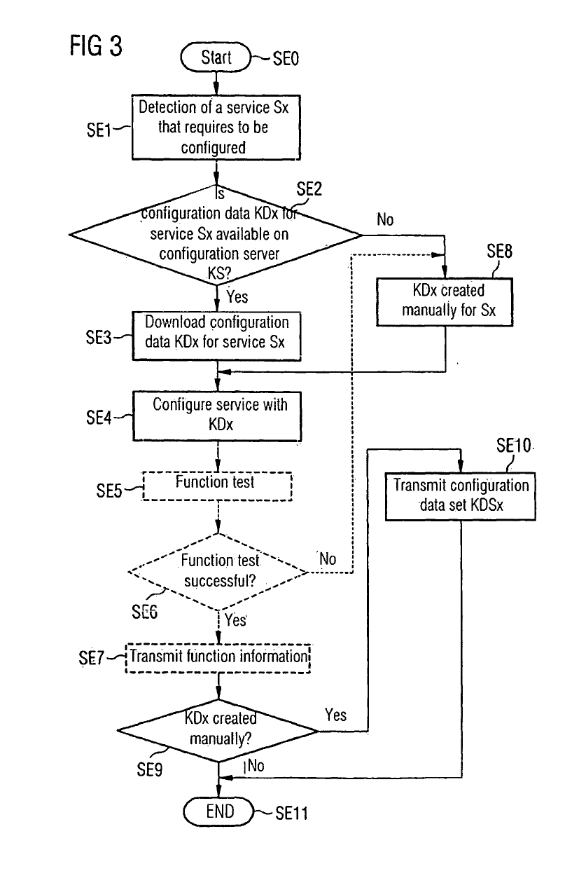

FIG. 3 is a simplified flow diagram showing how significant operations are performed in the terminal-side configuration method.

After starting in operation SE0 a service Sx that needs to be configured is first detected in an operation SE1, wherein for example a selection function in a popup menu can be used to select an appropriate service from a selection list provided by the configuration server. This may be for example a VoIP service (voice over IP) and in particular a SIP service, it being in principle also possible to configure any other services on an appropriate terminal. VoIP services in particular, however, possess a very complex configuration, for which reason the present method is extremely helpful.

In an operation SE2 the availability of configuration data KDx or configuration data sets KDSx for the detected service Sx is checked on the configuration server KS, the configuration data or data sets corresponding to the detected service Sx being downloaded in an operation SE3 if said data is available on the configuration server KS, that is, if it is not only present but also released. According to FIG. 1, configuration data sets that have been released are held in an appropriate configuration list KL.

If it emerges from the availability check in operation SE2 that no configuration data KDx or configuration data sets KDSx of the appropriate kind are present or released on the configuration server KS, or that no appropriate configuration data or configuration data sets could be downloaded, the configuration data KDx is manually created as the current configuration data for the unconfigured service Sx in an operation SE8.

After the configuration data KDx has been downloaded or manually created as current configuration data, said current configuration data is used in an operation SE4 to configure the terminal TE for the detected service Sx. In the exemplary embodiment according to FIG. 1, the SIP server address for the VoIP service or service provider “Prov1” is set to sip.Prov1.de and the SIP port address is set to 5060. The STUN server address (where STUN=simple traversal of user datagram protocol (UDP) through network address translators (NATs)) is set to stun.Prov1.de, it being also possible to set further parameters or addresses.

Furthermore a function test on the terminal TE configured in this way for the detected service Sx can be run in an operation SE5, it being possible thereby to ascertain information such as function test information Fl. In the simplest case said function test information Fl can tell whether or not the detected service can in principle be run successfully with the terminal configured in this way. Furthermore the function test information can have yet further contents that describe for example a quality of the service configured in this way. According to FIG. 3 the function test in operation SE5 is performed immediately after the service has been configured in operation SE4. Said function test can however also be performed at any other time, and in particular whilst the terminal is in normal use.

In a further optional operation SE6 the result of the function test can be evaluated or queried, it being also possible for the function test information Fl to be transmitted to the configuration server KS in an operation SE7 if the function test performed in operation SE5 was in principle successful or positive. On the other hand, if the evaluation of the function test in operation SE6 gives a negative result or the function test was unsuccessful, it is still possible to branch to operation SE8 and create the configuration data set KDSx or the configuration data KDx for the associated service Sx manually.

Moreover in an operation SE9 the presence of manually created configuration data KDx or of a configuration data set KDSx can be checked, wherein the current configuration data KDx and its associated detected service Sx or the configuration data set KDSx are transmitted in an operation SE10 if manually created configuration data was detected in operation SE9. The method ends in an operation SE11.

Although according to FIG. 3 operation SE9 that checks for the presence of manually created configuration data is arranged after the optional transmission of the function test information in operation SE7, in principle it is also possible to run said operation at an earlier time, in particular before the function test in operation SE5.

The method shown in simplified form in FIG. 3 is moreover not confined to an initial configuration, but can also be used in cases where a user creates or changes configuration data at a later time. Stated more precisely, this means that operation SE8 can also be accessed unconditionally if a particular user so wishes (not shown).

For example, operations SE5 to SE7 dealing with the function test take place in a particular terminal. However, they can also be run at a central point, such as by simulation in a server or by special “test” terminals.

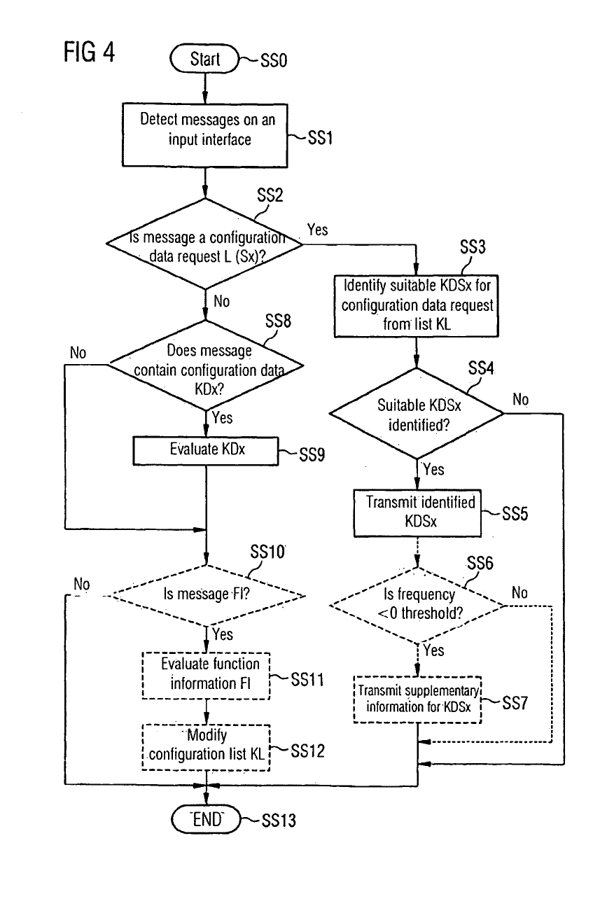

FIG. 4 is a simplified flow diagram showing how significant operations can be performed in a server-side method for supporting the configuration of terminals. The method according to FIG. 4 is therefore preferably performed in the configuration server KS.

According to FIG. 4, after the start in operation SS0 messages can initially be detected on an input interface, in particular the configuration server KS. Stated more precisely, terminal messages transmitted by terminals over the network N, such as a configuration data request L(Sx), a configuration data set KDSx, configuration data KDx, a detected service Sx or function test information Fl, are received and detected at this point.

In an operation SS2 the detected terminal messages can then be evaluated and checked, wherein on receiving a configuration data request L(Sx) for a service Sx needing to be configured, a suitable configuration data set KDSx or configuration data KDx for the service Sx is identified from the configuration list KL in an operation SS3. In an operation SS4 a check is made on whether suitable configuration data KDx or configuration data set KDSx was successfully identified in operation SS3. If the result is negative, the method terminates at operation SS13. However, if for example a suitable configuration data set KDSx was found, in a subsequent operation SS5 this will be transmitted over the telecommunication network N to the requesting telecommunication terminal TE as suitable configuration data KDx or configuration data set KDSx.

Furthermore in a subsequent operation SS6, the number or frequency of occurrence of the transmitted configuration data set KDSx can optionally be checked, wherein in an operation SS7 supplementary information on the transmitted configuration data set KDSx is transmitted to the telecommunication terminal TE; said information can be for example an exclusion of warranty if the number or frequency checked in operation SS6 is lower than a predetermined threshold. By this it can be ascertained that configuration data sets that have been used by only a small number of terminals are still considered unreliable or defective.

If however the check on the detected terminal messages determines that they do not amount to a configuration data request L(Sx) for a service, then in operation SS8 the system branches to a further inquiry in which the detected terminal messages are checked to find out whether they may contain or represent configuration data KDx or a configuration data set KDSx. If configuration data KDx or a configuration data set KDSx are present, the configuration data KDx or configuration data set KDSx are evaluated in a further operation SS9.

In the simplest case, when configuration data for a certain service Sx is evaluated, the transmitted configuration data is compared with the configuration data or configuration data sets already received, and for identical configuration data or configuration data sets a counter is incremented or a frequency (number/duration) is determined for an appropriate configuration data set KDSx. Said counter status or frequency of occurrence can furthermore be used in order that with effect from a certain threshold a configuration data set is released, being then stored in the configuration list KL of the configuration server KS.

Furthermore when the configuration data is being evaluated in SS9 it is also possible for just certain parameters in the configuration data set or configuration data to be compared, wherein again a counter is incremented or a frequency of occurrence of the parameter is determined for identical predetermined parameters. When the configuration data is being evaluated in this special way, it is possible for the frequency of the parameters to be used for generating a composite or combined configuration data set.

Stated more precisely, for a predetermined service Sx the parameters with the maximum frequency can be combined in a way that produces a new composite configuration data set having improved configuration characteristics.

Furthermore according to FIG. 4, in an operation SS10 the detected terminal messages can optionally be checked to find out whether any function test information Fl may exist about predetermined configuration data KDx or a predetermined configuration data set KDSx. If so, in operation SS11 this function test information Fl can be evaluated in an optional evaluation of function test information.

Thus in an operation S12, the configuration list KL and/or the configuration data sets KDSx contained in said list can be modified not only by reference to the evaluation result obtained in the evaluation operation SS9, but also by reference to the evaluation result optionally obtained in operation SS11. In this case modification can represent a rearrangement of the configuration data sets within the configuration list by reference to their frequencies and/or by reference to the evaluated function test information. In the same way the modification in operation SS12 can also imply an alteration to the configuration data within a configuration data set, wherein optimum parameters are combined with one another by reference to their number or frequency and/or the function test information Fl in each case. The method ends in an operation S13.

By this appropriate configuration data sets can be provided for a plurality of users, even in very exotic cases, that is, rare services from possibly very small service providers, without significant expenditure on configuration server maintenance. Costs are thus severely limited.

The proposed method and apparatus have been described above with the aid of wireless mobile telecommunication terminals, such as mobile telephones, conducting an exchange of configuration data with a configuration server over an IP-based network. Themethod and apparatus are not however limited to this application, also applying in equal measure to hardwired telecommunication terminals which likewise conduct an exchange of configuration data with a configuration server over any other network.

Furthermore the method and apparatus are not limited to the VoIP service described, and in particular the SIP service with associated terminal, but also applies in equal measure to any other services from alternative service providers together with the associated terminals, such as Internet radios, Internet TVs, set-top boxes etc.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-21. (canceled)

22. An apparatus for configuration of terminals comprising:
a service detection unit for detecting a service that needs to be configured for a terminal;
a transmitting/receiving unit for transmitting/receiving at least configuration data over a telecommunication network;
a control unit for controlling the transmitting/receiving unit so that configuration data associated with the detected service is downloaded from a configuration server in the telecommunication network and treated as current configuration data; and
a configuration unit for configuring the terminal for the detected service with the current configuration data.

23. The apparatus as claimed in claim 22,
further comprising:
a configuration data input unit for manually entering configuration data for the service that needs to be configured,
wherein the control unit routes the manually entered configuration data to the configuration unit as the current configuration data for the service, and
wherein the control unit transmits said data, via the transmitting/receiving unit, to the configuration server in the network.

24. The apparatus as claimed in claim 22,
further comprising:
a configuration function test unit for carrying out a function test on the service in the terminal for the current configuration data, thereby ascertaining function test information.

25. The apparatus as claimed in claim 24,
wherein the transmitting/receiving unit transmits the function test information to the configuration server together with the associated current configuration data and associated service.

26. The apparatus as claimed in claim 24,
wherein the transmitting/receiving unit transmits the current configuration data and associated service to the configuration server only if the function test is successfully performed.

27. The apparatus as claimed in claim 22,
wherein the apparatus is implemented in the terminal.

28. The apparatus as claimed in claim 22,
wherein:
the terminal comprises a mobile telecommunication terminal;
the network comprises an IP-based telecommunication network; and
the service comprises a VoIP service.

29. A method for configuration of terminals, comprising:
detection of a service that needs to be configured for a terminal;
downloading configuration data as current configuration data for the detected service, from a configuration server, over a telecommunication network; and
configuring the terminal for the detected service with the current configuration data.

30. The method as claimed in claim 29, further comprising:
checking the availability of configuration data for the detected service on the configuration server, and
downloading said configuration data if available.

31. The method as claimed in claim 29, further comprising:
executing a function test on the terminal using the current configuration data for the detected service, and
ascertaining the function test information.

32. The method as claimed in claim 31, further comprising:
evaluating the function test, and
transmitting the function test information to the configuration server if the function test is successfully performed.

33. The method as claimed in claims 30, further comprising:
manually creating configuration data as the current configuration data for the service needing to be configured,
if the availability test determines that no configuration data is available for the service, or
if the function test evaluation determines that the function test was not performed successfully.

34. The method as claimed in claim 33, further comprising:
checking for the existence of manually created configuration data, and
transmitting the current configuration data and the associated detected service to the configuration server if the check found manually created configuration data to be present.

35. The method as claimed in claim 34,
further comprising:
performing the check for the existence of manually created configuration data before or after the function test.

36. The method as claimed in claim 29,
wherein:
the terminal comprises a mobile telecommunication terminal;
the network comprises an IP-based telecommunication network; and
the service comprises a VoIP service.

37. A method for server-side support for configuration of terminals, comprising:
detecting messages from terminals transmitted over a telecommunication network;
checking the detected terminal messages,
determining suitable configuration data for the service from a configuration list;
transmitting the configuration data to the requesting terminal if a configuration data request for a service needing to be configured is present, and
performing a configuration data evaluation if configuration data exists for an associated service; and
modifying a configuration list from the configuration server by reference to the configuration data evaluation.

38. The method as claimed in claim 37,
further comprising:
comparing the currently transmitted configuration data to the configuration data already available when configuration data is evaluated for a certain service, and
determining the number or frequency of an associated configuration data set for identical configuration data.

39. The method as claimed in claim 38,
further comprising:
comparing only predetermined parameters from the configuration data when configuration data is evaluated for a certain service, and
determining the number or frequency of the parameters for identical predetermined parameters.

40. The method as claimed in claim 39,
further comprising:
using the number or frequency of the parameters for generating a composite or combined configuration data set when the configuration data is evaluated.

41. The method as claimed in claim 38,
wherein the number or frequency of the parameters or configuration data sets is checked and supplementary information is transmitted if the number or frequency of occurrence is below a predetermined threshold.

42. The method as claimed in claim 41,
wherein the supplementary information comprises an exclusion of warranty for a dispatched configuration data set.

43. The method as claimed in claim 37, further comprising:
checking the detected terminal messages,
performing a function test evaluation if function test information about predetermined configuration data and an associated service is present, and
modifying the configuration list on the configuration server as by reference to said function test information.

44. The apparatus as claimed in claim 23,
further comprising:
a configuration function test unit for carrying out a function test on the service in the terminal for the current configuration data, thereby ascertaining function test information.

45. The apparatus as claimed in claim 44,
wherein the transmitting/receiving unit transmits the function test information to the configuration server together with the associated current configuration data and associated service.

46. The apparatus as claimed in claim 45,
wherein the transmitting/receiving unit transmits the current configuration data and associated service to the configuration server only if the function test is successfully performed.

47. The apparatus as claimed in claim 46,
wherein the apparatus is implemented in the terminal.

48. The apparatus as claimed in claim 47,
wherein:
the terminal comprises a mobile telecommunication terminal;
the network comprises an IP-based telecommunication network; and
the service comprises a VoIP service.
